(19) United States
(12) Patent Application Publication
(10) Pub. No.: US 2026/0192280 A1
(43) Pub. Date: Jul. 9, 2026

(54) DENSIFIED METAL-ORGANIC FRAMEWORK (MOF) ADSORBENTS FOR ENHANCED GAS SEPARATION

(71) Applicants: Sameh K. Elsaidi, Orland Park, IL (US); Mona H. Mohamed, Orland Park, IL (US)

(72) Inventors: Sameh K. Elsaidi, Orland Park, IL (US); Mona H. Mohamed, Orland Park, IL (US)

(21) Appl. No.: 19/445,048

(22) Filed: Jan. 9, 2026

Related U.S. Application Data
(60) Provisional application No. 63/743,552, filed on Jan. 9, 2025.

(51) Int. Cl. B01J 20/22; B01D 53/02; B01J 20/28

(52) U.S. Cl. CPC B01J 20/226; B01D 53/02; B01J 20/28011; B01D 2253/204; B01D 2257/504; B01D 2258/0283

(57) ABSTRACT

Densified metal-organic frameworks (MOFs) and methods for manufacturing densified MOFs tailored to enhance gas separation processes. The methods employ an innovative densification method utilizing several techniques, including particle downsizing, systematic compression, and/or defect engineering, to minimize distances between particles. These processes effectively regulate the crystal structure, interparticle interactions, pore characteristics, and gas diffusion within the framework. The densified MOFs address challenges in gas separation technologies, offering scalable, energy-efficient solutions for applications such as CO2/hydrocarbon separation to Kr/Xe separation.

### CROSS REFERENCE TO RELATED APPLICATION

This application claims the benefit of U.S. Provisional Patent Application, Ser. No. 63/743,552, filed on 9 Jan. 2025. The co-pending provisional application is hereby incorporated by reference herein in its entirety and is made a part hereof, including but not limited to those portions which specifically appear hereinafter.

### GOVERNMENT SUPPORT CLAUSE

This invention was made with government support under DE-SC0024594 awarded by U.S. Department of Energy. The government has certain rights in the invention.

### FIELD OF THE INVENTION

This invention relates generally to metal-organic frameworks (MOFs) and, more particularly, to methods for manufacturing, and the resulting, densified metal-organic frameworks (MOFs) tailored to enhance gas separation processes.

### BACKGROUND OF THE INVENTION

Metal-organic frameworks (MOFs) constitute a large and rapidly expanding class of crystalline porous materials, with well over one hundred thousand distinct structures reported to date. These materials have been extensively evaluated through gas adsorption and separation studies, demonstrating exceptional potential for gas storage, separation, and related applications. Such evaluations are most often performed on MOFs in the form of loose crystals or fine powders, which do not reflect their practical, end-use configurations.

In real-world applications, MOF powders present substantial engineering limitations due to their low bulk density, poor mechanical integrity, dustiness, and difficulty in system integration. To address these challenges, MOFs are commonly processed into shaped forms such as pellets, beads, or monoliths that are compatible with industrial separation systems. Among these approaches, pelletization, typically achieved through the application of mechanical pressure, with or without binders, has emerged as the most widely adopted method for MOF densification and commercialization.

However, the application of mechanical pressure during densification can induce significant structural changes within the MOF, including phase transformations, pore deformation, partial amorphization, or framework collapse. As a result, separation properties measured on pristine MOF powders frequently fail to predict performance under practical operating conditions.

Densification-induced structural modifications are not inherently detrimental. In certain cases, changes in pore size, pore shape, or framework topology may generate emergent transport or selectivity behavior that is not accessible in the undensified material. These effects highlight the need for controlled densification strategies that enable systematic investigation of structure-property relationships in shaped MOFs.

There is a continued need for effective densification mechanisms and processing techniques that preserve or intentionally tailor the internal structure of MOFs while increasing their bulk density. Such approaches would enable the study and optimization of densification-induced structural transformations and allow the rational design of shaped MOFs with enhanced separation performance under realistic, end-use conditions, including separations that are not achievable using conventional powder-based materials

### SUMMARY OF THE INVENTION

A general object of the invention is to provide materials and methods for gas separation, specifically metal-organic frameworks (MOFs) engineered to preferentially adsorb one material over another, such as krypton over xenon or carbon dioxide over hydrocarbons. The invention provides MOFs with reversed selectivity mechanisms. In embodiments, the invention addresses challenges in hydrocarbon purification and carbon dioxide capture using densification techniques. In addition, the invention provides for improved krypton (Kr)/xenon (Xe) separation, which is an essential process in nuclear waste management and dark matter research. The densified MOF materials of embodiments of this invention demonstrate unprecedented Kr selectivity at room temperature, attributed to reduced gas diffusion and a tailored pore architecture.

Embodiments of this invention use a new approach to engineering MOFs, such as HKUST-1 (CuBTC), to achieve inverse selectivity. By employing densification, the invention modifies the structural flexibility of MOFs, enabling selective adsorption of gases. In embodiments, the densification process involves shearing and contraction of the MOF crystal lattice, resulting in a tetragonal structure with reduced and preferably minimal interparticle voids. These structural changes enhance gas selectivity, for example, carbon dioxide or krypton selectivity, while reducing hydrocarbon or xenon adsorption. Experimental and simulation studies confirm the effectiveness of this approach, demonstrating significant improvements in selectivity and gas separation efficiency.

The general object of the invention can be attained, at least in part, through a method of densifying a metal-organic framework (MOF), by adding a coordination modulator to a reaction mixture of a metal salt and a MOF ligand, to slow MOF nanoparticle growth and/or introduce MOF structural defects.

By downsizing the MOF particles, the invention promotes particle adherence, resulting in a more densely packed structure. Parallelly, the deliberate introduction of defects bolsters the interaction between adjacent nanoparticles. In embodiments, the method modulates the molecular interactions between MOF nanoparticles. Through chemical interactions, neighboring crystallites are stitched together, leading to enhanced particle adhesion and reduced intergranular voids. The invention can effectively regulate MOF flexibility, resulting in remarkable adsorption properties.

The invention further includes a method of forming a MOF, including: combining a metal salt with a MOF ligand in a reaction mixture to form MOF nanoparticles; adding a coordination modulator to the solution to slow growth of the MOF nanoparticles and/or introduce structural defects; and retrieving a densified MOF material.

The coordination modulator competes with the MOF ligand and affects MOF crystallization to form the MOF structural defects. The MOF structural defects reduce interparticle voids through physical or chemical interactions between adjacent nanoparticles to provide a densified MOF. In embodiments, the densified MOF comprises a gel. The densifying increases a bulk density of the MOF to at least 90% of a theoretical crystallographic density. More desirably, the densifying induces a change in crystal symmetry such that a measured density of the densified MOF is greater than 100% of a theoretical density derived from the crystal structure.

In embodiments, the coordination modulator comprises a monodentate ligand, which competes with the MOF ligand for, and blocks reaction sites on, metal surfaces in the MOF nanoparticles. The monodentate ligand desirably includes a heteroatom including an oxygen, a nitrogen, or a sulfur donor atom.

The densifying generally affects gas selectivity and diffusion into the densified MOF. The gel form material provides further application benefits. In embodiments, the densified MOF is drop-casted or otherwise applied or molded to create densified MOF sheets/layers/articles. In embodiments, the gel MOF material is sprayed on a surface. In other embodiments, the gel MOF material is molded and dried to form a solidified MOF structure.

The invention further includes a MOF embodied as a gel material of densified MOF nanoparticles having structural defects. The densified MOF comprises a bulk density of at least 90% of a theoretical crystallographic density for the MOF. The densified MOF generally has asymmetrical crystallinity with reduced intergranular voids. In embodiments, the densified MOF nanoparticles exhibit a selectivity at ambient temperature and pressure of at least one of: krypton over xenon, or carbon dioxide over hydrocarbons.

In embodiments, the MOFs have particle sizes less than 50 nm, more desirably less than 40 nm, preferably less than 30 nm, and in embodiments between 10-30 nm, achieved through controlled synthesis and processing. The gas adsorption and separation properties are distinct from the traditional powder form.

In embodiments, a method for synthesizing densified MOFs includes: combining metal components selected from alkali metals, alkaline earth metals, transition metals, lanthanides, or combinations thereof, with organic ligands in a solvent to form a reaction mixture; enabling the formation of MOFs with a particle size of less than 50 nm; introducing structural defects by partially omitting a portion of the ligands or metal sites to create flexible or vacant sites within the MOF structure; and/or using MOFs inherently designed for flexibility by densifying the resulting material through one or more of the following processes: air drying, vacuum evacuation, heating, chemical crosslinking, irradiation crosslinking, or combinations thereof, wherein the densified MOF exhibits modified pore characteristics and enhanced gas selectivity compared to its powdered form.

The invention further includes a method for fabricating and processing MOFs for versatile applications. The method includes applying the MOF reaction mixture onto a surface, through techniques such as commercial paint spraying, molding, knife casting, and/or drop casting; drying the applied material to form continuous and uniform coatings on the surface, wherein the resulting MOFs are adaptable for industrial-scale applications, including coatings and gas separation modules. The MOFs can further be used to form monolithic structures including chunks of varying sizes, strands, or self-standing sheets.

The invention further includes a method for enhanced separation processes. The method includes engineering tailored MOF pore architecture and minimizing interparticle voids to control gas diffusion pathways, and facilitating the selective adsorption and separation of gases, including but not limited to: CO2 over hydrocarbons such as C2H2, C2H4, and C2H6, and Krypton (Kr) over Xenon (Xe).

As used herein, references to “theoretical crystallographic density” are understood to refer to the calculated, ideal density of a perfect crystal, typically found by dividing the mass of atoms within a single unit cell by the unit cell's volume, using the formula: Density+(n×A)/(VC×NA) where n is atoms per cell, A is atomic weight, VC is unit cell volume, and NA is Avogadro's number, representing the material's maximum possible density before imperfections.

Other objects and advantages will be apparent to those skilled in the art from the following detailed description taken in conjunction with the appended claims and drawings.

### BRIEF DESCRIPTION OF THE DRAWINGS

FIG. 1 illustrates a traditional MOF framework.

FIG. 2 illustrates a densified MOF framework according to embodiments of this invention.

FIGS. 3A-C illustrate the skeletal density of CuBTC_{TWP} (washed powder, FIG. 3A), Mono-CuBTC (FIG. 3B) and FS-CuBTC (FIG. 3C).

FIGS. 4A-B illustrate single-gas adsorption isotherms for CH4, C2H2, C2H4, C2H6, and CO2 at 298 K for CuBTC_{TWP} (washed powder, FIG. 4A), and FS-CuBTC (flat sheets, FIG. 4B) of this invention.

FIGS. 5A-B illustrate gas uptake profiles and diffusion behaviors for CO2 and hydrocarbons in CuBTC_{TWP} and FS-CuBTC. FIG. 5A and FIG. 5B compare the time-dependent gas uptake profiles for CO2 and hydrocarbons between the traditional powdered materials and the densified materials of embodiments of this invention.

FIG. 6 illustrates the column breakthrough curves of equimolar quinary mixture of CH4, C2H2, C2H4, C2H6, and CO2 for FS-CuBTC, demonstrating the separation performance under practically relevant conditions.

FIG. 7 illustrates the cyclic dynamic breakthrough tests of equimolar quinary mixture of CH4, C2H2, C2H4, C2H6, and CO2 using a packed bed of FS-CuBTC, highlighting the material's regeneration capability and stability.

FIGS. 8 and 9 illustrate pore A and pore B, respectively, of the examples discussed herein, sharing one common bIm linker in the activated ZIF-7_{pwd} triclinic structure (FIG. 8) and activated ZIF-7ₘₒₙₒ rhombohedral structure (FIG. 9).

FIGS. 10A-B illustrate the skeletal density of ZIF-7_{pwd} (FIG. 10A) and ZIF-7ₘₒₙₒ (FIG. 10B). FIG. 10B shows that the densified materials of this invention are much denser than the powder form.

FIGS. 11A-11D show gas adsorption isotherms of CO2 and C2 hydrocarbons at 298 K in the activated materials of ZIF-7_{pwd} (FIG. 11A), ZIF-7ₘₒₙₒ (FIG. 11B), ZIF-9_{pwd} (FIG. 11C) and ZIF-9ₘₒₙₒ (FIG. 11D).

FIG. 12 illustrates gas uptake profiles and diffusion behaviors for CO2 and hydrocarbons in ZIF-7ₘₒₙₒ.

FIGS. 13A-B illustrate the column breakthrough curves of equimolar quinary mixture of CH4, C2H2, C2H4, C2H6, and CO2 for ZIF-7ₘₒₙₒ (FIG. 13A) and ZIF-9ₘₒₙₒ (FIG. 14B), demonstrating the separation performance under practically relevant conditions.

FIG. 14 illustrates cyclic dynamic breakthrough tests of equimolar quinary mixture of CH4, C2H2, C2H4, C2H6, and CO2 using a packed bed of ZIF-7ₘₒₙₒ, highlighting the material's regeneration capability and stability.

FIGS. 15A-C illustrate single-gas adsorption isotherms for Xe and Kr at 298 K for CuBTC_{TWP} (FIG. 15A), Mono-CuBTC (FIG. 15B) and FS-CuBTC (FIG. 15C) of this invention.

FIG. 16 illustrates Kr/Xe selectivity of FS-CuBTC at 298 K.

FIG. 17 illustrates time-dependent gas uptake profiles for Xe and Kr in the densified material of embodiments of this invention, showing the faster diffusion of Kr in FS-CuBTC and the slower diffusion of Xe, emphasizing its kinetic selectivity.

FIGS. 18A-B illustrate the column breakthrough curves of a 1:1 Kr/Xe mixture (FIG. 18A) and a 1:10 Kr/Xe mixture (FIG. 18B) for FS-CuBTC, demonstrating the separation performance under practically relevant conditions.

FIG. 19 illustrates cyclic dynamic breakthrough tests of a 1:1 Kr/Xe mixture using a packed bed of FS-CuBTC, highlighting the material's regeneration capability and stability.

FIGS. 20A-B illustrate a nanoindentation study for the invented densified material's mechanical stability before and after radiation.

### DETAILED DESCRIPTION OF THE INVENTION

The present invention includes a novel method for manufacturing densified metal-organic frameworks (MOFs) tailored to enhance gas separation processes. Traditional MOF-based adsorbents often face challenges such as rapid saturation, poor selectivity, or limited applicability in demanding environments. To overcome these limitations, the disclosed invention employs an innovative densification method utilizing several techniques, including particle downsizing, systematic compression, and/or defect engineering, to minimize the distance between particles. These processes effectively regulate the crystal structure, interparticle interactions, pore characteristics, and gas diffusion within the framework. The densified MOFs show great potential in addressing critical challenges in gas separation technologies, offering scalable, energy-efficient solutions for applications such as carbon dioxide/hydrocarbon separation to Kr/Xe separation.

The invention provides a new strategy designed to enhance or change gas selectivity by modulating gas diffusion and the intrinsic “breathing” behavior characteristic of MOF frameworks. The invention provides a binder-free and pressure-free densification method aimed at achieving optimal packing of MOF crystals. The method is anchored in one or more foundational tactics: 1) the deliberate reduction of particle size and 2) introducing surface defects. By downsizing the MOF particles, the invention promotes closer particle adherence, resulting in a more densely packed structure. The deliberate introduction of defects can bolster the interaction between adjacent nanoparticles. In embodiments, the crux of the densification strategy stems from its capacity to erect dual-action diffusion barrier. First, it counters the natural flexibility of MOF structures by physically restricting nanoparticle mobility, effectively eliminating the framework's propensity for “breathing,” which reflects a feature that often compromises selectivity through undesired adsorbate accommodations. Second, it reduces interparticle voids, creating an additional layer of resistance against gas diffusion and thereby enhancing the material's selective adsorption properties. The impact of these orchestrated effects is strikingly evidenced in the performance leap of the densified MOF materials of this invention. Upon densification, the MOF materials all show notable and often different (e.g., generally reversed) gas selectivity. This advancement is attributed to the significant contrast in diffusivity between gases. By throttling the “breathing” mechanism and governing molecular access, the invention demonstrates ability to redefine the separation properties of flexible MOFs.

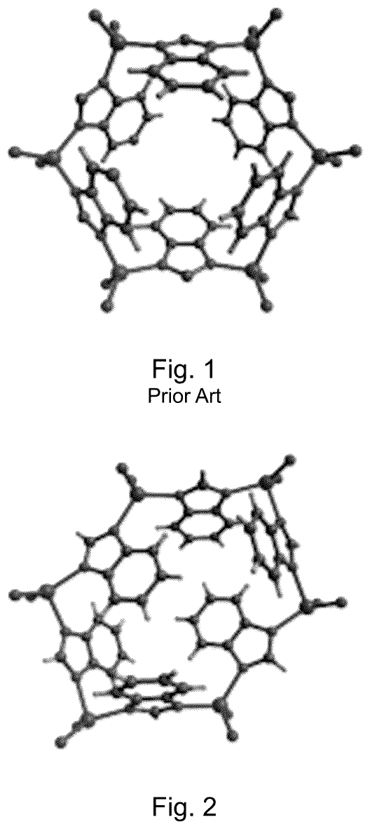

The invention includes a method of densifying a MOF by adding a coordination modulator to a reaction mixture of the MOF elements, namely a metal salt and a MOF ligand. The coordination modulator acts to slow MOF nanoparticle growth and/or introduce MOF structural defects. The coordination modulator competes with the MOF ligand for metal binding and affects MOF crystallization to form the MOF structural defects. The coordination modulator slows MOF nanoparticle growth, reducing interparticle voids through physical or chemical interactions between adjacent nanoparticles to provide a densified MOF. FIG. 1 shows a representative MOF without the method of this invention. FIG. 2 shows a densified version of a MOF according to this invention. The change in crystal structure represented by FIG. 2 provides an altered pore structure, generally having reduced pore sizes. The reduction in pore size significantly hampers gas diffusion within confined spaces, resulting in increased selectivity favoring gases with greater ease of passage through the pores.

Exemplary metal salts for use in the method include a metal selected from alkali metals, alkaline earth metals, transition metals, lanthanides, or combinations thereof. More specific examples include copper salts, zinc salts, cobalt salts, nickel salts, zirconium salts, and magnesium salts. Exemplary MOF ligands include benzene tricarboxylate (BTC) ligands, dicarboxylate ligands, tetracarboxylate ligands, pentacarboxylate ligands, hexacarboxylate ligands, dihydroxycarboxylate ligands, imidazolates, triazolates, tetrazolate, amine-based ligands, pyridine-based ligands, or combinations thereof

[symbol]

In embodiments, the coordination modulator is a monodentate ligand, also sometimes referred to as monotropic ligand. A monodentate ligand is a molecule or ion that binds to a central metal atom or ion at only one point, using a single donor atom with one lone pair of electrons. The monodentate ligand competes with the MOF ligand for, and blocks reaction sites on, metal surfaces in the MOF nanoparticles, resulting in smaller size nanoparticles and structural defects resulting in, for example, asymmetrical crystallinity with reduced intergranular voids. Exemplary monodentate ligands include heteroatoms with an oxygen, a nitrogen, or a sulfur donor atom.

The densifying of this invention affects gas selectivity and diffusion into the densified MOF. In embodiments, the gas selectivity results in a change or reversal of gas adsorption. Exemplary densified MOF nanoparticles of this invention exhibit a selectivity at ambient temperature and pressure of at least one of: krypton over xenon, or carbon dioxide over hydrocarbons. For example, the MOF of FIG. 1 represents a zeolitic imidazolate framework (ZIF) ZIF-7, and FIG. 2 represents a densified form of ZIF-7 according to this invention. During testing at 0.5 bar, a pressure characterized by either closed or partially open gates in ZIF-7, the selectivity increased by 2, 4, and 9.5 times for CO2 over C2H2, C2H4, and C2H6, respectively, in the densified ZIF-7. In other testing, a hydrocarbon-selective copper-1,3,5-benzenetricarboxylate MOF (“CuBTC MOF,” also known as HKUST-1) experienced a change in structure to a densified CuBTC that led to a significant selectivity reversal, with notable carbon dioxide absorption improvements (e.g., observed in CO2/C2H6: 4416 vs 0.61; in CO2/C2H4: 15 vs 0.28; and in CO2/C2H2: 4 vs 0.2). The densified material also shows impressive separation, regeneration, and recyclability during dynamic breakthrough experiments with complex quinary gas mixtures.

Densifying MOFs according to this invention generally induces a change in crystal symmetry such that a measured density of the densified MOF is increased. In embodiments, the invention includes a densified MOF with a bulk density of at least 90% of a theoretical crystallographic density for the MOF, desirably at least 95%, and more desirably at least 100%.

The densified MOFs of this invention provide for changed material types. For example, the MOF of FIG. 1 is generally collected and used as a powder. The densified MOF of this invention has a smaller size that doesn't precipitate as easily from the reaction mixture solvent and remains suspended. In embodiments, the MOF is in a gel form that provides for unique applications. In embodiments, the gel is applied to a surface (e.g., stainless steel, glass, or plastic), such as by drop casting, knife casting, or spraying, and dried to form continuous and uniform coating on surfaces, or monolithic structures including chunks of varying sizes, strands, or self-standing sheets. The gel material can further be molded and dried to form a solidified MOF material

[symbol]

The densified MOFs of this invention can be employed in various industrial applications, such as where MOFs are currently used. Exemplary uses include hydrocarbon purification in petrochemical industries, carbon dioxide capture (e.g., from flue gases in power plants), separation of volatile radionuclides, separation of Xe and Kr from air, separation of light hydrocarbons for chemical manufacturing, and/or enhanced gas storage solutions.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

The method of this invention was used to engineer CuBTC (HKUST-1), to achieve inverse carbon dioxide/C2-hydrocarbon selectivity. The densification and defect engineering of the invention modified the structural flexibility of the CuBTC MOFs, enabling selective adsorption of CO2. The densification process involved shearing and contraction of the MOF crystal lattice, resulting in a tetragonal structure with minimal interparticle voids. These structural changes enhanced CO2 selectivity and diffusion rates while reducing hydrocarbon adsorption. Experimental and simulation studies confirmed the effectiveness of this approach, demonstrating significant improvements in CO2 selectivity and gas separation efficiency.

The densified CuBTC material was synthesized by combining copper acetate (CuAc; 1 mmol) with benzene tricarboxylate (BTC; 1 mmol) ligands in a 1:1 water-ethanol mixture. Acetic acid (0.5 mmol) was used as the coordination modulator to introduce structural defects. The reaction formed a gel-like material, which was drop-cast onto glass sheets to create densified flat sheets (FS-CuBTC). The densification process induced shearing and contraction of the crystal lattice, transitioning the structure from cubic to tetragonal. The resulting material, FS-CuBTC, was washed with ethanol, sonicated, and vacuum-activated at 150° C. for 12 hours. The final densified product exhibited uniform pore structures and a tetragonal crystal lattice.

The reaction conditions were optimized to achieve a uniform gel formation. Copper acetate served as the metal source due to its ability to maintain the copper dimer paddlewheel configuration intrinsic to HKUST-1. The introduction of acetic acid slowed the growth of the MOF particles, allowing for controlled defect formation. This method also facilitated particle stitching through free carboxylates interacting with neighboring copper ions, creating a highly dense structure with minimal voids.

The gel-like material was highly versatile, allowing application via commercial paint sprayers or casting onto surfaces such as stainless steel, glass, and plastics using knife or drop-casting techniques. Once dried, it formed continuous coatings. It could also be molded into various forms, such as monolithic chunks, strands, or self-standing sheets, by transferring the gel into molds and solidifying it. This adaptability eliminates the need for high-speed centrifugation, a common requirement for densifying many monolithic materials.

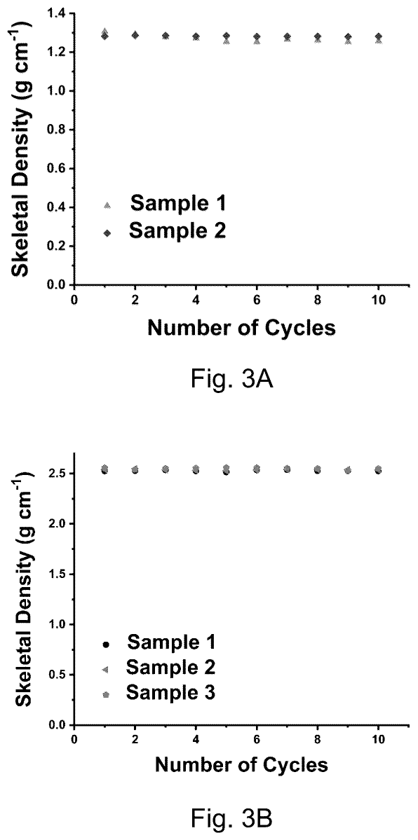

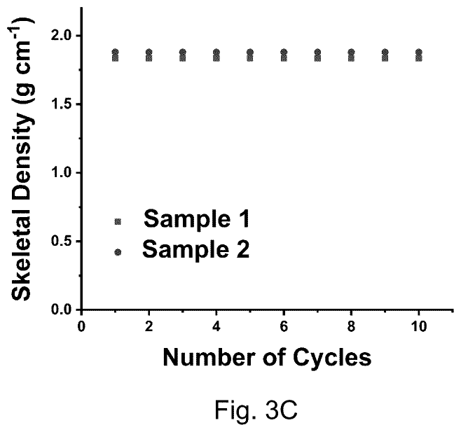

FIGS. 3A-C illustrate the skeletal density of CuBTC_{TWP} (washed powder, FIG. 3A), Mono-CuBTC (FIG. 3B) and FS-CuBTC (FIG. 3C). FIGS. 3B-C show that the densified materials of this invention are much denser than the powder form.

Powder X-ray diffraction (PXRD) confirmed the transformation of the CuBTC structure from cubic to tetragonal symmetry. The densified FS-CuBTC exhibited a drastic reduction in pore size compared to its powdered counterpart, as revealed by nitrogen adsorption isotherms conducted at 77 K. Thermal stability tests using thermogravimetric analysis (TGA) showed that the FS-CuBTC material could withstand temperatures up to 325° C., making it suitable for industrial applications.

Transmission electron microscopy (TEM) studies indicated a tightly packed arrangement of nanoparticles with negligible interparticle voids. This unique structural arrangement was key to the material's enhanced selectivity and performance.

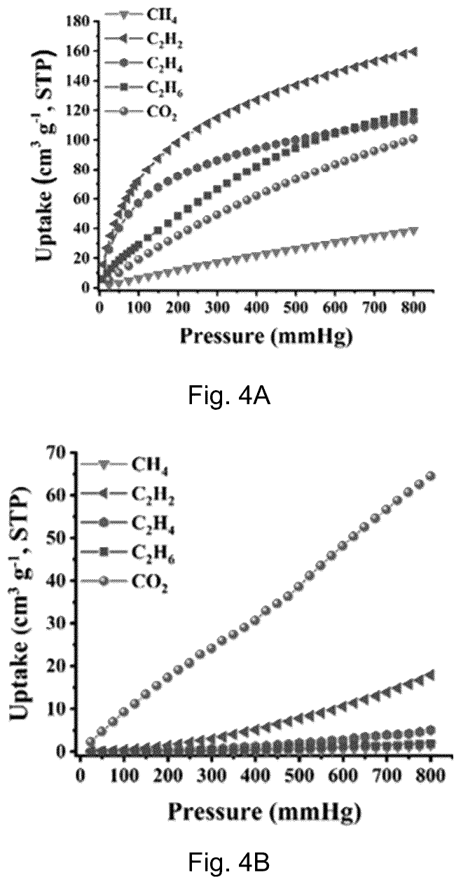

Adsorption isotherms for CO2, C2H2, C2H4, and C2H6 were measured using a volumetric gas analyzer at 298 K, with findings summarized in FIGS. 4A-B. FS-CuBTC demonstrated a CO2 uptake of 4 mmol/g at 1 bar, significantly higher than its hydrocarbon counterparts. This selectivity was consistent across multiple samples, confirming the material's reliability.

Dynamic breakthrough experiments demonstrated the superior gas separation capabilities of FS-CuBTC. A column packed with FS-CuBTC was exposed to an equimolar quinary gas mixture of CO2, C2H2, C2H4, C2H6, and CH4 at 298 K and 1 bar. CO2 was selectively adsorbed, with hydrocarbons eluting almost immediately. The breakthrough time for CO2 exceeded 10 minutes, demonstrating its strong interaction with the MOF framework.

In binary gas mixtures, CO2 was selectively adsorbed while hydrocarbons rapidly eluted. For quinary mixtures containing CO2, C2H2, C2H4, C2H6, and CH4, FS-CuBTC achieved near-complete CO2 separation with negligible hydrocarbon adsorption. This behavior was attributed to the interplay of kinetic diffusion and size exclusion mechanisms facilitated by the densified structure.

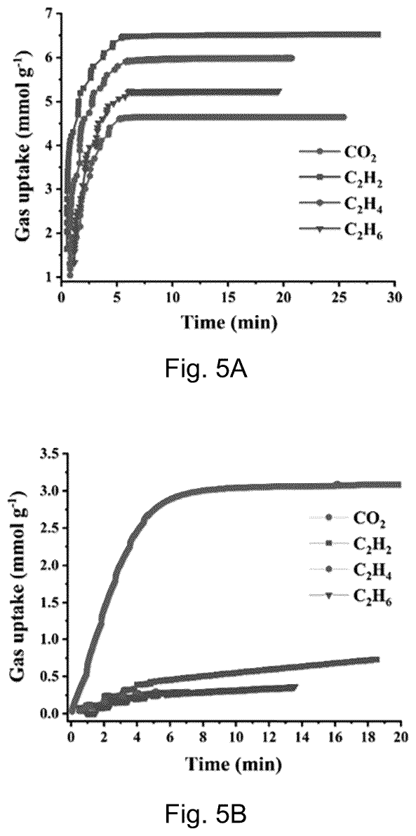

FIGS. 5A-B illustrate gas uptake profiles and diffusion behaviors for CO2 and hydrocarbons in CuBTC_{TWP} and FS-CuBTC. FIG. 5A and FIG. 5B compare the time-dependent gas uptake profiles for CO2 and hydrocarbons between the traditional powdered materials and the inventive densified materials.

Simulation studies supported these findings, showing faster diffusion of CO2 molecules through the pore network compared to hydrocarbons. The material's performance exceeded existing benchmarks, such as Mg-MOF-74 and 5A zeolite, making it a promising candidate for CO2 purification and hydrocarbon feedstock production.

For comparison, dynamic breakthrough experiments were conducted on powdered CuBTC and FS-CuBTC under identical conditions. While powdered CuBTC showed moderate CO2 adsorption, it failed to separate CO2 from hydrocarbons effectively. In contrast, FS-CuBTC exhibited superior selectivity and separation efficiency, confirming the advantages of the densification process.

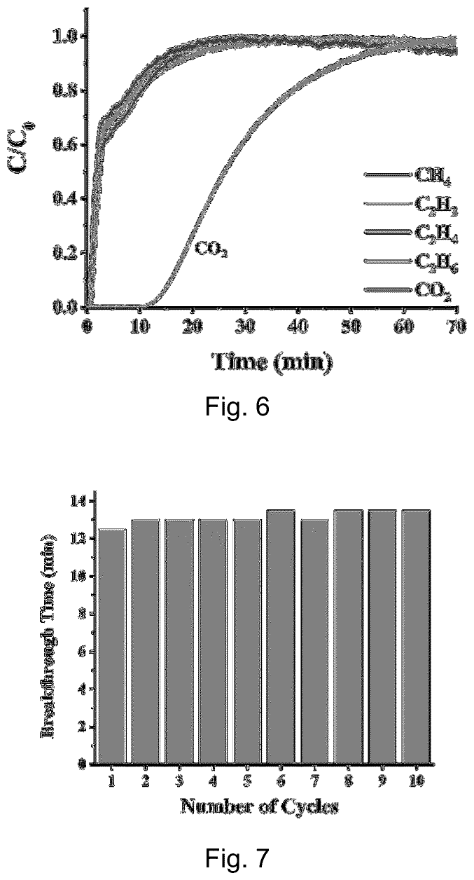

FIG. 6 illustrates the column breakthrough curves of equimolar quinary mixture of CH4, C2H2, C2H4, C2H6, and CO2 for FS-CuBTC, demonstrating the separation performance under practically relevant conditions. FIG. 7 illustrates the cyclic dynamic breakthrough tests of equimolar quinary mixture of CH4, C2H2, C2H4, C2H6, and CO2 using a packed bed of FS-CuBTC, highlighting the material's regeneration capability and stability.

The FS-CuBTC material was subjected to 10 adsorption-desorption cycles using CO2 at 298 K. Regeneration involved purging with helium for 30 minutes at room temperature. The material retained over 98% of its initial adsorption capacity, highlighting its durability and potential for repeated use in industrial processes.

The densification method of this invention was also applied to ZIF-7 and its isostructural MOF, ZIF-9, which shares the bIm linker but has cobalt in place of zinc. Small-sized particles of both ZIF-7 and ZIF-9 were achieved by conducting the reaction at room temperature with the assistance of triethylamine (Et3N) as the modulator, and subsequently quenching the reaction immediately once the solution exhibited turbidity. The resulting materials, upon drying, formed monolithic sheets: ZIF-7mono and ZIF-9mono. To provide a basis for comparison, ZIF-9 and ZIF-7 powder materials (ZIF-7pwd and ZIF-9pwd) were synthesized using established procedures. ZIF-7mono appears as white monolithic chunks, while ZIF-9mono is characterized by a shiny dark purple color, both exhibiting a transparent appearance, particularly noticeable in thinner pieces.

The structural properties of these materials were studied by microscopic and analytical techniques. Scanning electron microscopy (SEM) images reveal that the particle size of powder samples, ZIF-7pwd and ZIF-9pwd, varied from approximately 0.5-2 μm, whereas the ZIF-7mono and ZIF-9mono particles are significantly smaller, measuring approximately 10 to 30 nm. The SEM study also confirmed that the densified materials were composed of a single phase of aggregated nanoparticles. Moreover, thermogravimetric analysis underscored comparable thermal stability for the monolithic and powdered samples, with all variants exhibiting stability up to 525° C. Further structural characterization was performed through CO2 adsorption isotherms at 195K, providing key parameters such as surface area and pore volume. The Brunauer-Emmett-Teller (BET) surface area (SA) of ZIF-7pwd, ZIF-9pwd, ZIF-7mono and ZIF-9mono were found to be 290, 238, 218 and 168 m²/g, respectively.

To investigate the gating phenomena in these frameworks, synchrotron powder X-ray diffraction (syncPXRD) studies were performed on the powder and monolithic forms before and after activation (solvent removal). Pawley refinement revealed the crystal structures of these materials and confirmed that ZIF-7ₘₒₙₒ and ZIF-9ₘₒₙₒ preserved their rhombohedral crystal structure post-activation. In contrast, the activated ZIF-7pwd and ZIF-9pwd samples underwent substantial structural transitions, adopting a low-symmetry, narrow-pore structure with a triclinic crystal lattice, consistent with previous reports. Thus, the densification process effectively impedes the typical linker rotation in the framework, preventing the structural transformation from large-pore (lp) to narrow-pore (np) that usually occurs upon solvent removal. This observation underscores the superior change in the structural properties imparted by the densification process, highlighting the effectiveness of this approach in establishing a stable configuration for the pores within these MOFs.

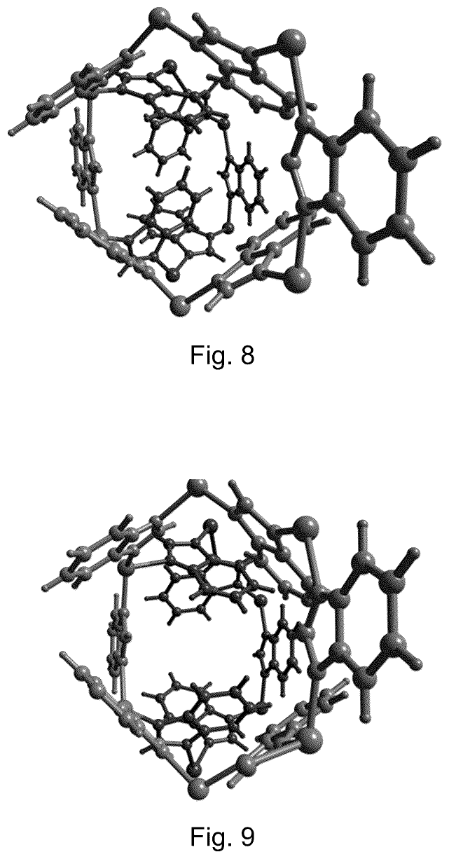

Adsorption properties of the densified materials were assessed to discern any functional changes concomitant with the structural locking induced by densification in ZIF-7mono and ZIF-9mono. In ZIF-7, CO2 adsorption is stabilized through hydrogen bonding with the bIm linker. Research indicated that pore B (FIG. 9) remains consistent between ZIF-7-I (R-3) and ZIF-7-II (P-1), accommodating CO2 through weak interactions with a single hydrogen atom on the imidazole ring. Conversely, pore A (FIG. 8), variable in size between ZIF-7-I (lp) and ZIF-7-II (np), is postulated to serve as the primary host for CO2, given its interaction with two hydrogen atoms on the benzene ring of bIm linker. However, pore A accessibility is mediated via pore B, evidenced by its larger window.

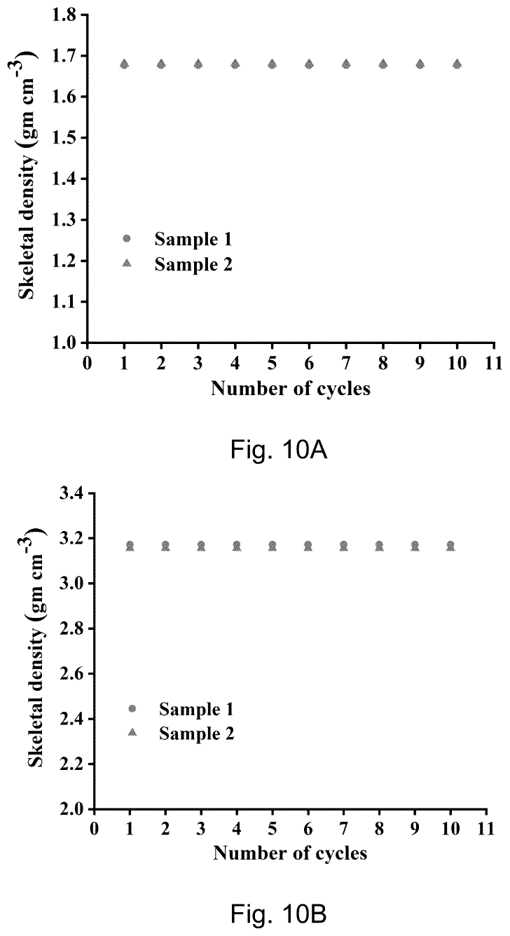

FIGS. 10A-B summarize the skeletal density of ZIF-7_{pwd} (FIG. 10A) and ZIF-7ₘₒₙₒ (FIG. 10B). FIG. 10B shows that the densified materials of this invention are much denser than the powder form.

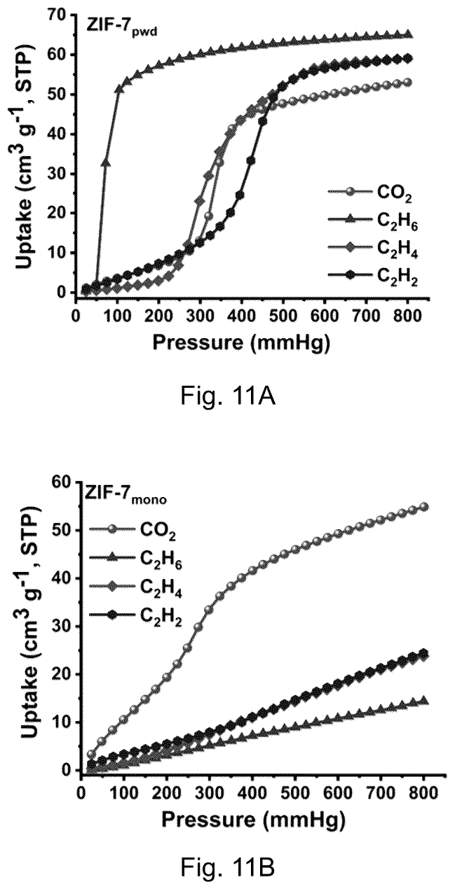

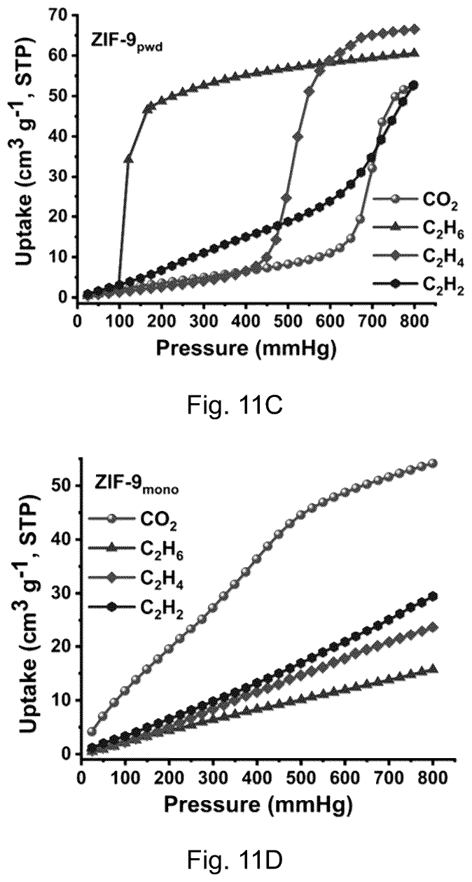

In powder form, ZIF-7pwd and ZIF-9pwd showed low CO2 uptakes at low pressures (see FIGS. 11A and 11C). Following activation, ZIF-7pwd transitions to ZIFpwd-7-II (P-1) narrow pore configuration, hindering the entry of CO2 molecules to pore A and culminating in a modest uptake of merely 0.4 mmol/g at a pressure of 0.4 bar. This continued until CO2 accumulation within pore B reached a critical juncture, prompting linker rotation and the subsequent opening of pore A. By increasing the pressure, the powder materials exhibited a pronounced abrupt increase in CO2 adsorption, aligning with the transition from the narrow pore A of ZIFpwd-7-II (P-1) to the large pore A of ZIF-7pwd-I (R-3). Intriguingly, ZIF-7mono and ZIF-9mono demonstrated no discernible steps in their CO2 adsorption isotherms, an indication that the activated materials retained their large-pore structure, predisposing them to CO2 adsorption even at low pressures. At the adsorption pressure that instigates the transition from a narrow pore (np) to large pore (lp) structure, ZIF-7mono demonstrates a CO2 adsorption capacity approximately three times greater than that of ZIF-7pwd, and for ZIF-9mono, it is approximately five times (see FIGS. 11B and 11D). For example, at 0.3 bar, CO2 uptakes were 0.35, 0.19, 1, and 0.96 mmol/g for ZIF-7pwd, ZIF-9pwd, ZIF-7mono, and ZIF-9mono, respectively. These observations emphasize the potential efficacy of this densification approach in stabilizing the desirable structural properties of these MOFs and enhancing their performance.

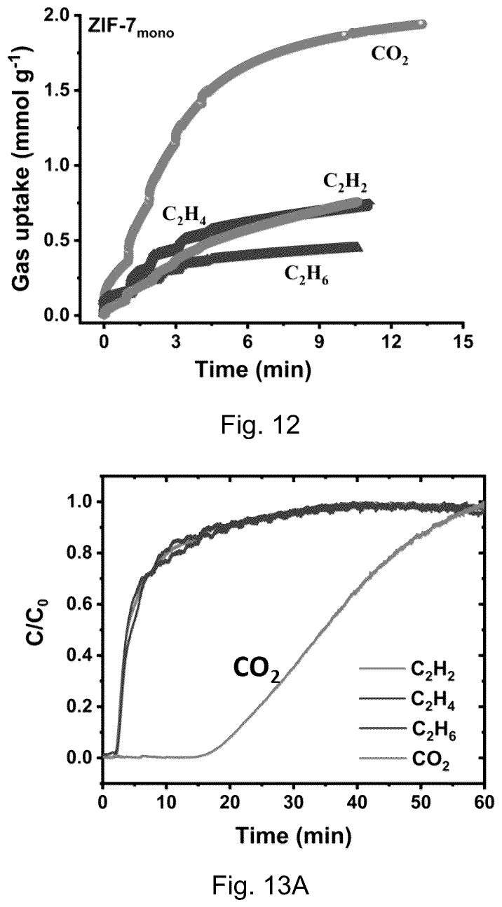

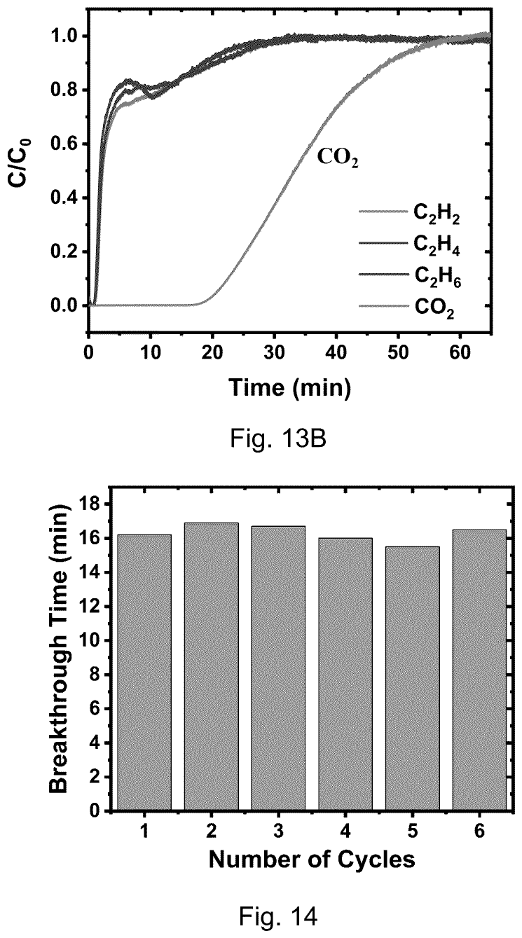

FIG. 12 summarizes gas uptake profiles and diffusion behaviors for CO2 and hydrocarbons in ZIF-7ₘₒₙₒ. FIG. 12 compares the time-dependent gas uptake profiles for CO2 and hydrocarbons in the inventive densified material, showing the faster diffusion of CO2 over the hydrocarbons. FIGS. 13A-B illustrate column breakthrough curves of an equimolar quinary mixture of CH4, C2H2, C2H4, C2H6, and CO2 for ZIF-7ₘₒₙₒ (FIG. 13A) and ZIF-9ₘₒₙₒ (FIG. 13B), demonstrating the separation performance under practically relevant conditions.

FIG. 14 summarize the cyclic dynamic breakthrough tests of equimolar quinary mixture of CH4, C2H2, C2H4, C2H6, and CO2 using a packed bed of ZIF-7ₘₒₙₒ, highlighting the material's regeneration capability and stability.

In summary, the findings showcase that under systematic densification conditions, these monolithic materials exert unique control over gas diffusion into their pores, exhibiting a remarkable preference for adsorbing CO2 over hydrocarbons. This extraordinary selectivity emerges from the dense aggregation of MOF particles and the restraint of structural transitions typically associated with ZIF-7 and ZIF-9 MOFs, achieved by constraining the benzene ring rotation of the benzimidazolate ligands. This dual-pronged approach forms a formidable blockade for gas diffusion, operating within both the structural confines of the MOF and between the particles. The significance of this structural-locking approach lies in its distinctiveness, presenting an innovative solution that diverges from previously reported techniques for controlling MOF flexibility, including linker functionalization, external stimuli, and guest molecule triggering, and localized movements of organic linkers. This approach not only paves the way for promising applications in carbon capture and sequestration, but also underscore the broader potential of leveraging the densification process for controlling gas diffusion and flexibility in MOFs. This has the potential to enhance targeted gas selectivity and overall performance in various gas adsorption and separation applications.

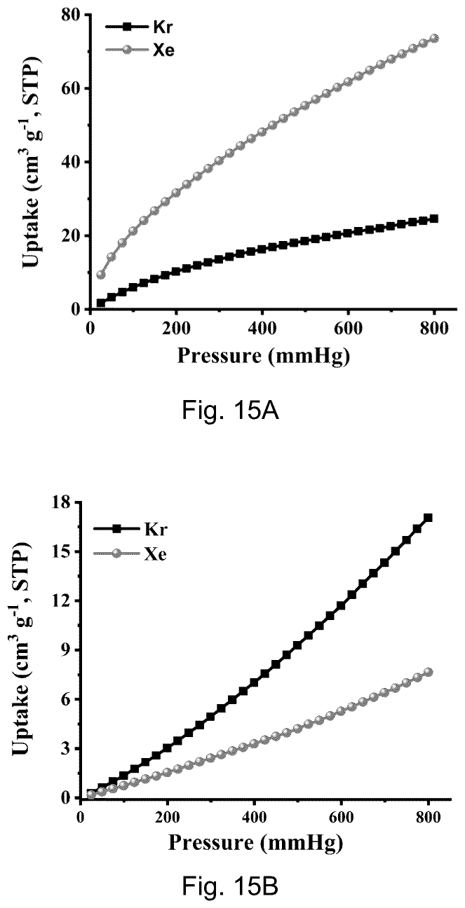

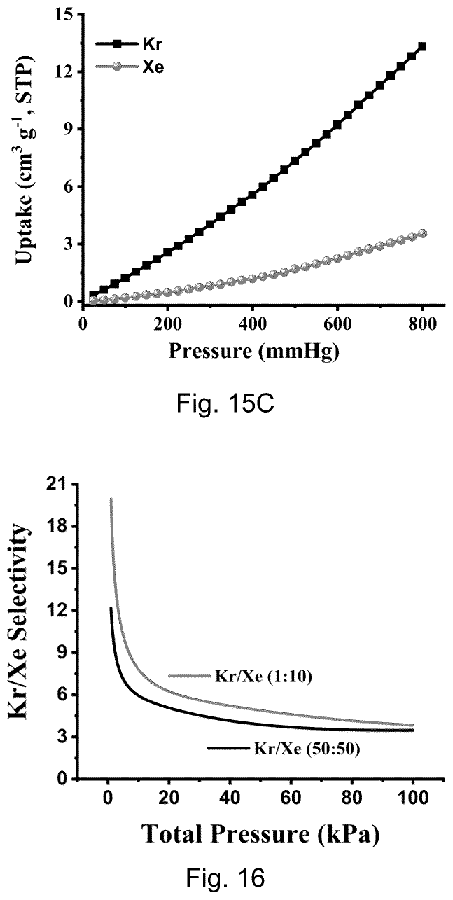

MOFs of this invention were further tested for separation of xenon and krypton. FIGS. 15A-C summarize single-gas adsorption isotherms for Xe and Kr at 298 K for CuBTC_{TWP} (FIG. 15A), Mono-CuBTC (FIG. 15B) and FS-CuBTC (FIG. 15C) of this invention. The isotherms in FIGS. 15B and 15C show a reverse selectivity for Mono-CuBTC and FS-CuBTC (both Kr-selective) compared to CuBTC_{TWP} (Xe-selective) at room temperature. This behavior is attributed to the reduced pore size and interparticle voids and slower gas diffusion in densified materials, which favors the faster-diffusing Kr over Xe. FIG. 16 illustrates Kr/Xe selectivity of FS-CuBTC at 298 K.

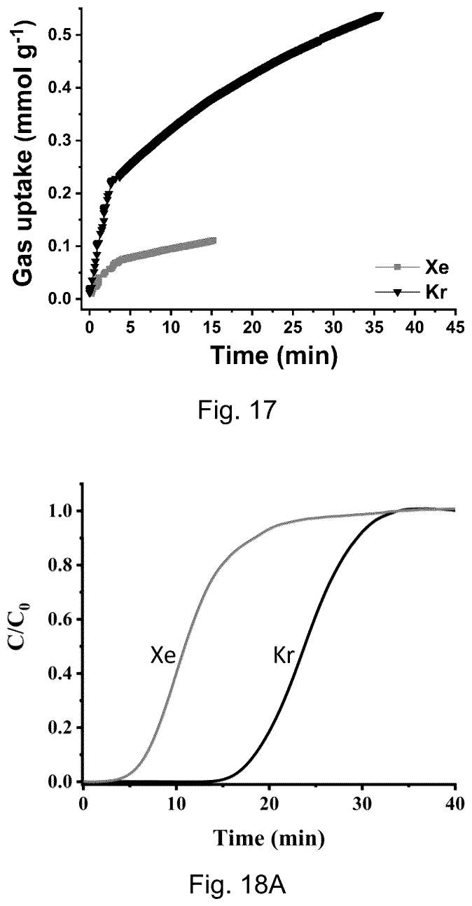

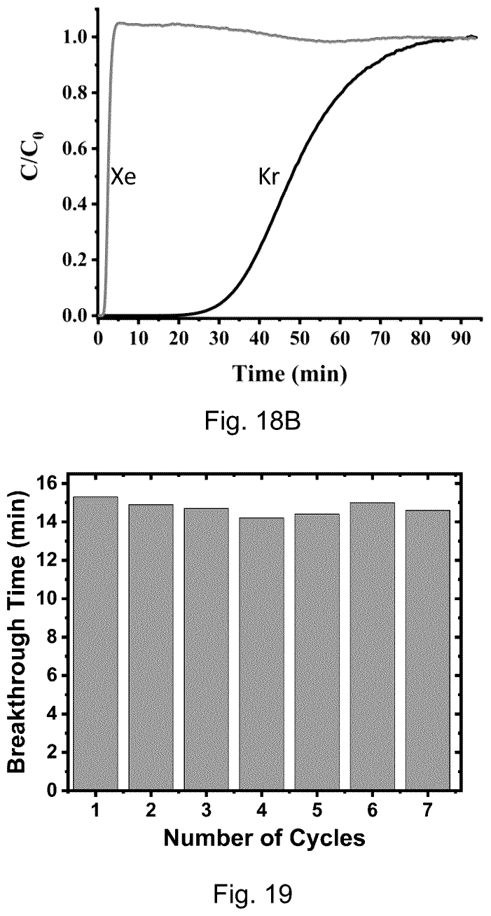

FIG. 17 summarize time-dependent gas uptake profiles for Xe and Kr in the inventive densified material, showing the faster diffusion of Kr in FS-CuBTC and the slower diffusion of Xe, emphasizing its kinetic selectivity. FIGS. 18A-B summarize the column breakthrough curves of a 1:1 Kr/Xe mixture (FIG. 18A) and a 1:10 Kr/Xe mixture (FIG. 18B) for FS-CuBTC, demonstrating the separation performance under practically relevant conditions.

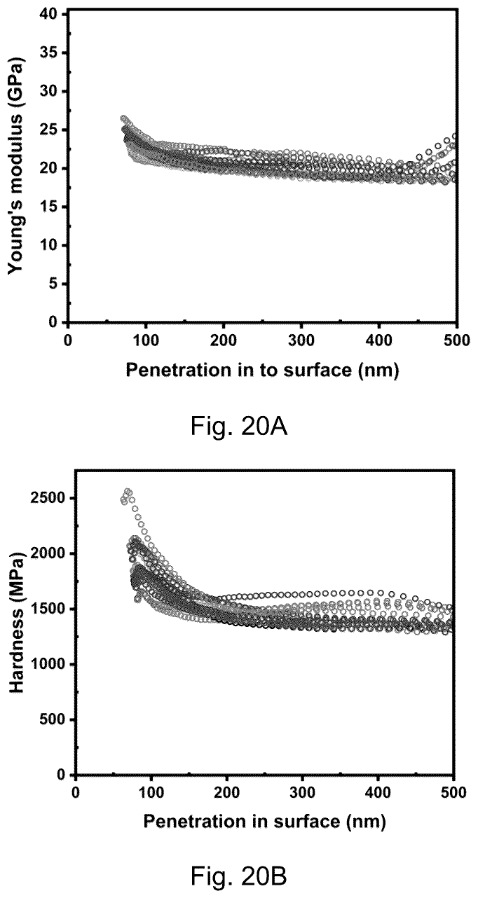

FIG. 19 summarize cyclic dynamic breakthrough tests of a 1:1 Kr/Xe mixture using a packed bed of FS-CuBTC, highlighting the material's regeneration capability and stability. FIGS. 20A-B summarize a nanoindentation study for the invented densified material's mechanical stability before and after radiation. Young's modulus of (A) hardness (B) after irradiation of FS-CuBTC at 800 kGy. FIGS. 20A-B show the mechanical robustness of the invented densified material after irradiation of up to 800 kGy.

Thus, the invention provides a densification process that effectively impedes the typical linker rotation in the MOF framework, preventing the structural transformation from large pore to narrow pore that usually occurs upon solvent removal. The changes in the structural properties imparted by the densification process herein provide a stable pore configuration while providing different gas selectivity.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of densifying a metal-organic framework (MOF), by adding a coordination modulator to a reaction mixture of a metal salt and a MOF ligand, to slow MOF nanoparticle growth and/or introduce MOF structural defects.

2. The method of claim 1, wherein the coordination modulator competes with the MOF ligand and affects MOF crystallization to form the MOF structural defects.

3. The method of claim 1, wherein the slow MOF nanoparticle growth and structural defects reduce interparticle voids through physical or chemical interactions between adjacent nanoparticles to provide a densified MOF.

4. The method of claim 3, wherein the densified MOF comprises a gel.

5. The method of claim 3, wherein the densifying increases a bulk density of the MOF to at least 90% of a theoretical crystallographic density.

6. The method of claim 3, wherein densifying induces a change in crystal symmetry such that a measured density of the densified MOF is greater than 100% of a theoretical density derived from the crystal structure.

7. The method of claim 1, wherein the coordination modulator comprises a monodentate ligand.

8. The method of claim 7, wherein the monodentate ligand competes with the MOF ligand for, and blocks reaction sites on, metal surfaces in the MOF nanoparticles.

9. The method of claim 7, wherein the monodentate ligand comprises a heteroatom including an oxygen, a nitrogen, or a sulfur donor atom.

10. The method of claim 1, wherein the densifying affects MOF framework flexibility and/or gas selectivity and diffusion into the densified MOF.

11. A method of forming a metal-organic framework (MOF), the method comprising:
combining a metal salt with a MOF ligand in a reaction mixture to form MOF nanoparticles;
adding a coordination modulator to the solution to slow growth of the MOF nanoparticles and/or introduce structural defects; and
retrieving a densified MOF material.

12. The method of claim 11, wherein the slow growth of the MOF nanoparticles reduces nanoparticle size and reduces interparticle voids to provide the densified MOF.

13. The method of claim 11, wherein the densified MOF material is a gel MOF material.

14. The method of claim 13, further comprising drop-casting the gel MOF material to create densified MOF sheets.

15. The method of claim 13, further comprising spraying the gel MOF material on a surface.

16. The method of claim 13, further comprising molding and drying the gel MOF material to form a solidified MOF material.

17. The method of claim 11, wherein the coordination modulator comprises a monodentate ligand, which competes with the MOF ligand for, and blocks reaction sites on, metal surfaces in the MOF nanoparticles.

18. The method of claim 17, wherein the monodentate ligand comprises a heteroatom including an oxygen, a nitrogen, or a sulfur donor atom.

19. A metal-organic framework (MOF) comprising a gel material of densified MOF nanoparticles having structural defects.

20. The MOF of claim 19, wherein the densified MOF comprises a bulk density of at least 90% of a theoretical crystallographic density for the MOF.

21. The MOF of claim 19, wherein the densified MOF comprises asymmetrical crystallinity with reduced intergranular voids.

22. The MOF of claim 19, wherein the densified MOF nanoparticles exhibit a selectivity at ambient temperature and pressure of at least one of: krypton over xenon, or carbon dioxide over hydrocarbons.
